(19) United States
(12) Patent Application Publication
(10) Pub. No.: US 2017/0090088 A1
(43) Pub. Date: Mar. 30, 2017

(54) LIGHT-EMITTING APPARATUS

(71) Applicant: Panasonic Intellectual Property Management Co., Ltd., Osaka (JP)

(72) Inventors: Atsushi MOTOYA, Shiga (JP); Hiroshi KITANO, Hyogo (JP); Kenichiro TANAKA, Osaka (JP)

(21) Appl. No.: 15/276,200

(22) Filed: Sep. 26, 2016

(30) Foreign Application Priority Data
Sep. 30, 2015 (JP) 2015-193959

(51) Int. Cl. F21V 8/00; G02B 6/02; B63C 11/18; F21V 7/00

(52) U.S. Cl. CPC G02B 6/001; G02B 6/0008; F21V 7/00; G02B 6/02; G02B 6/0003; B63C 11/18

(57) ABSTRACT

A light-emitting apparatus includes: a flexible base body; and a light-emitting component which is attached to the base body, has a form which changes flexibly following a change in the firm of the base body, and includes: a light guide which guides laser light that enters one end of the light guide; a leaking means for causing part of the laser light guided by the light guide to leak out of the light guide in a direction which crosses a light-guiding direction; and a first light-emitter which extends along the light-guiding direction and emits light based on the part of the laser light that is leaked out of the light guide by the leaking means.

### CROSS REFERENCE TO RELATED APPLICATION

This application claims the benefit of priority of Japanese Patent Application Number 2015-193959 filed on Sep. 30, 2015, the entire content of which is hereby incorporated by reference.

### BACKGROUND

1. Technical Field

The present disclosure relates to a light-emitting apparatus including a base body having a form that changes.

2. Description of the Related Art

Conventionally, there is proposed a technique relating to a light-emitting apparatus which has a flexible base body to which light-emitting diodes (LEDs) are attached at a plurality of locations. By freely bending the base body, the arrangement of the LEDs can be changed so that the light-emitting apparatus can emit light in a state that adequately conforms to the shape of the installation site (see Japanese Unexamined Patent Application Publication No. 2014-41752, for example).

### SUMMARY

The conventional light-emitting apparatus, however, makes use of light sources, such as LEDs, which use electricity to emit light, and requires at least one loop of electrical wire and electrical contacts for connecting each of the light sources with the electrical wire. Therefore, the wiring structure becomes complicated and short-circuiting between electrical wires, rusting of contacts, etc., occurs when used in a moist environment such at sea or in a disaster area, and thus durability over extended use is compromised.

A light-emitting apparatus according to an aspect of the present disclosure includes: a flexible base body; and a light-emitting component attached to the flexible base body and having a form which changes flexibly following a change in a form of the flexible base body, the light-emitting component including: a light guide which guides laser light that enters one end of the light guide; a leaking means for causing part of the laser light guided by the light guide to leak out of the light guide in a direction which crosses a light-guiding direction; and a first light-emitter which extends along the light-guiding direction and emits light based on the part of the laser light that is leaked out of the light guide by the leaking means.

The present disclosure provides a light-emitting apparatus which includes a flexible light-emitter that bends freely, and which emits light in a line form without using electricity at the vicinity of the light-emitter.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a diagram schematically illustrating surface-supplied diving to which a light-emitting apparatus according to an embodiment is applied;

FIG. 2 is a cross-sectional perspective view of a portion of a light-emitting apparatus according to an embodiment;

FIG. 3 is a cross-sectional view of a light-emitting component according to an embodiment when cut perpendicular to a light-guiding direction;

FIG. 4 is a cross-sectional view of a light-emitting component according to an embodiment when cut along to a light-guiding direction;

FIG. 5 is a cross-sectional view of an illuminating device according an embodiment;

FIG. 6 is a cross-sectional view of a light-emitting apparatus according to an embodiment;

FIG. 7 is a diagram illustrating a light-emitting state of a light-emitting apparatus according to an embodiment;

FIG. 8 is a cross-sectional perspective view of a light-emitting apparatus according another embodiment;

FIG. 9 is a diagram illustrating an example of use of a light-emitting apparatus according to another embodiment;

FIG. 10 is a perspective view of a light-emitting apparatus according another embodiment;

FIG. 11 is a cross-sectional perspective view of a light-emitting apparatus according another embodiment; and

FIG. 12 is a cross-sectional perspective view of a light-emitting apparatus according another embodiment.

### DETAILED DESCRIPTION OF THE EMBODIMENTS

Hereinafter, a light-emitting apparatus according to embodiments of the present disclosure will be described in detail with reference to the drawings. It should be noted that each of the subsequently-described embodiments shows a specific example. Therefore, numerical values, shapes, materials, structural components, the arrangement and connection of the structural components, etc. shown in the following embodiments are mere examples, and are not intended to limit the scope of the present disclosure. Furthermore, among the structural components in the following embodiment, components not recited in any one of the independent claims which indicate the broadest concepts of the present disclosure are described as arbitrary structural components.

Furthermore, the respective figures are schematic diagrams and are not necessarily precise illustrations. Moreover, in the respective figures, the same reference signs are given to the same structural components and portions having the same function.

### Embodiment 1

Hereinafter, a light-emitting apparatus used in surface-supplied diving which is one embodiment will be described using the drawings.

[Surface-Supplied Diving]

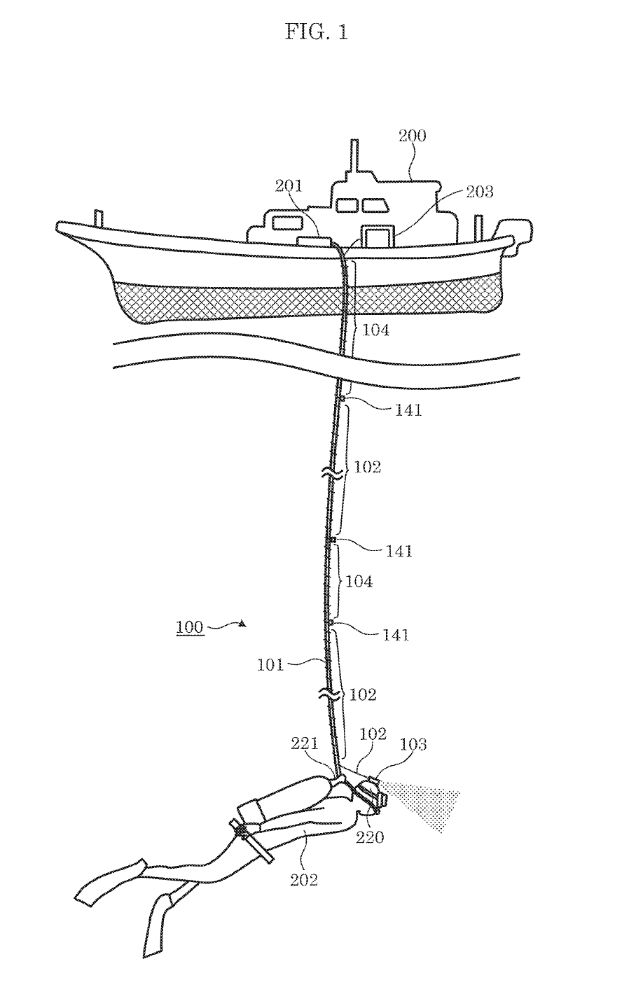

FIG. 1 is a diagram schematically illustrating surface-supplied diving to which a light-emitting apparatus is applied.

As illustrated in the figure, surface-supplied diving is a diving method in which a fluid breathing gas such as air that is needed by diver 202 is supplied through a hose called a hookah, etc., from breathing gas supply source 201, such a compressor or a tank filled with breathing gas, which is mounted on boat 200.

Here, diver 202 is working in dark waters of approximately 50 m in depth for example, and thus it is very difficult or impossible to see distant portions of the hose. Therefore, there are situations where the hose becomes entangled with existing structures or equipment placed in the water, or the hose becomes entangled with another diver's hose that was not visually recognized.

[Configuration of Light-Emitting Apparatus]

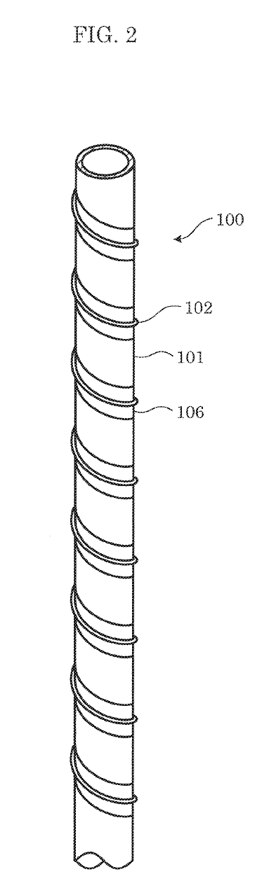

In view of this, light-emitting apparatus 100 according to this embodiment is an apparatus which, along with functioning as a hose for supplying breathing gas to diver 202, emits light in order to enhance visibility of the hose even in the deep sea, etc., which light does not reach. As illustrated in FIG. 2, light-emitting apparatus 100 includes base body 101 and light-emitting components 102.

(Base Body)

Base body 101 is a component having a form that changes flexibly. In this embodiment, since base body 101 is a tubular hose for supplying breathing gas to diver 202, base body 101 has an elongated external shape and is flexible, pliable, and resilient to some extent. It should be noted that although there is no particular limitation on the material of base body 101, in this embodiment, hose-shaped base body 101 is formed using rubber and is integrated with a metal wire (not illustrated) in order to ensure the tensile strength of base body 101.

As illustrated in FIG. 1, one end of base body 101 is connected to breathing gas supply source 201 provided on boat 200, and the other end of base 101 is connected to regulator 221 mounted on a helmet or a mask of diver 202.

(Light-Emitting Component)

Each of light-emitting components 102 is a component which emits light in a line form while attached to base body 101, and has a form that changes flexibly following a change in the form of base body 101.

In this embodiment, base body 101 is a component with an elongated external appearance, and light-emitting components 102 are attached spirally to the outer circumferential surface of base body 101. Furthermore, as illustrated in FIG. 1, one end of light-emitting component 102 receives laser light emitted from laser light source 203 provided on boat 200.

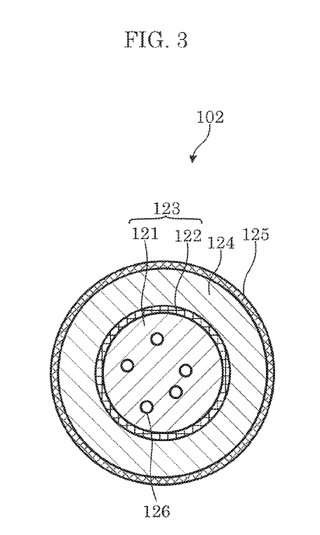

FIG. 3 is a cross-sectional view of the light-emitting component when cut perpendicular to a light-guiding direction of laser light.

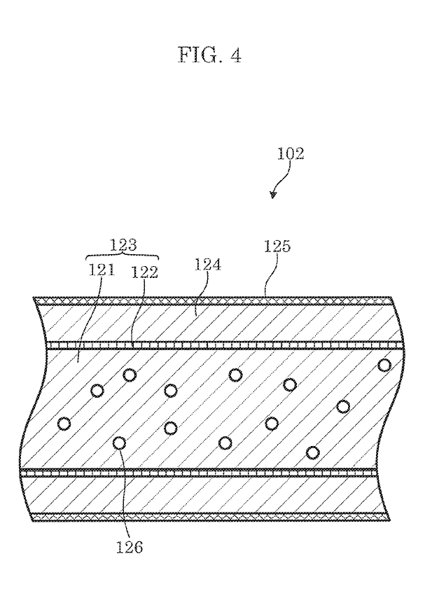

FIG. 4 is a cross-sectional view of the light-emitting component when cut along the light-guiding direction of laser light.

As shown in the figures, each of light-emitting components 102 includes light guide 123, leaking means 126, first light-emitter 124, and cover portion 125.

Light guide 123 is an optical fiber, or the like, which guides laser light oscillated by laser light source 203, and includes core 121 and cladding 122. In light guide 123, a higher refractive index is set for core 121 than for cladding 122 to thereby keep the laser light inside core 121 by way of total internal reflection, and guide the laser light efficiently. Core 121 and cladding 122 are made from a material that is highly transmissive of laser light, such as silica glass.

Leaking means 126 is a component or structure which causes part of the laser light that is guided by light guide 123 and passing inside core 121 to leak out (i.e., to be deflected or scattered) in a direction that crosses the light-guiding direction.

In this embodiment, leaking means 126 includes minute beads dispersed inside core 121. The beads have a surface that causes the laser light to be scattered, and part of the laser light that is scattered by leaking means 126 advances in a direction different from the light-guiding direction, and passes through cladding 122 to leak out of light guide 123.

It should be noted that leaking means 126 is not limited to beads dispersed inside core 121, and may include another component or structure. For example, leaking means 126 may be cavities (air bubbles) provided in a dispersed state inside core 121, etc. Furthermore, leaking means 126 may be a portion of cladding 122, which has a refractive index different from cladding 122 so as not to cause total internal reflection of the laser light passing inside core 121.

First light-emitter 124 is a portion which is disposed adjacent to light guide 123 along the light-guiding direction, and emits light based on the laser light that is leaked out from light guide 123 by leaking means 126. First light-emitter 124 is a component which includes, in a dispersed state, phosphor particles which generate fluorescence when excited by the laser light that has leaked out from light guide 123. Specifically, first light-emitter 124 can be exemplified as a component in which phosphor particles are dispersed inside a transparent base material. Furthermore, the base material is made of resin, etc., which is transparent to the laser light and the light radiated by the phosphors, and bends following a change in the form of base body 101.

It is sufficient that first light-emitter 124 include at least one type of phosphor. However, in this embodiment, first light-emitter 124 radiates white light by including three types of phosphors. More specifically, in order to radiate white light using, as an excitation light, a blue laser light or a laser light having a wavelength shorter than the blue laser light, first light-emitter 124 includes, in the appropriate ratio, three types of phosphors, namely, a first phosphor which emits red light, a second phosphor which emits blue light, and a third phosphor which emits green light. In this manner, radiation of white light is realized by the mixing of the beams of light of different wavelengths radiated by the three types of phosphors excited by the short-wavelength laser light. Here, the term “ratio” includes the case where at least one of the quantities is 0.

Although there is no particular limitation on the method for placing first light-emitter 124 on the outer circumferential surface of light guide 123, for example, first light-emitter 124 may be attached by applying a liquid base material (resin) containing phosphors onto the outer circumferential surface of light guide 123, or a sheet-shaped or cylindrical first light-emitter 124 may be laminated on to light guide 123.

It should be noted that phosphors may be included in cladding 122 of light guide 123, and the function of light guide 123 and the function of first light-emitter 124 may be combined.

Moreover, although there is no particular limitation on the appropriate ratio of the three types of phosphors, the ratio is changed as appropriate depending on the application of light-emitting apparatus 100. For example, when light-emitting apparatus 100 is used in a vertically extended state in the deep sea such as in the case of this embodiment, the ratio of the three types of phosphors may be different between a portion of first light-emitter 124 to be disposed at the greatest depth, a middle portion, and a portion disposed at the shallowest depth. Furthermore, the change in the ratio may be in stages or may be in a gradation.

Furthermore, first light-emitter 124 may include a function film for efficiently irradiating the phosphors with laser light, a function film for efficiently radiating emitted visible light, etc.

Cover portion 125 is a component which protects light-emitting component 102 from scrapes and scratches, and is capable of transmitting the light radiated from first light-emitter 124. Although there is no particular limitation on how cover portion 125 is formed or disposed around first light-emitter 124, a thin flexible resin tube may be disposed in close adhesion around first light-emitter 124. Furthermore, cover portion 125 may be formed by applying a liquid resin on first light-emitter 124, and hardening the resin using ultraviolet radiation, heat, etc.

It should be noted that cover portion 125 may include a scattering component or structure which scatters the laser light and reduces the coherence of the laser light that leaks from light-emitting component 102.

(Illuminating Device)

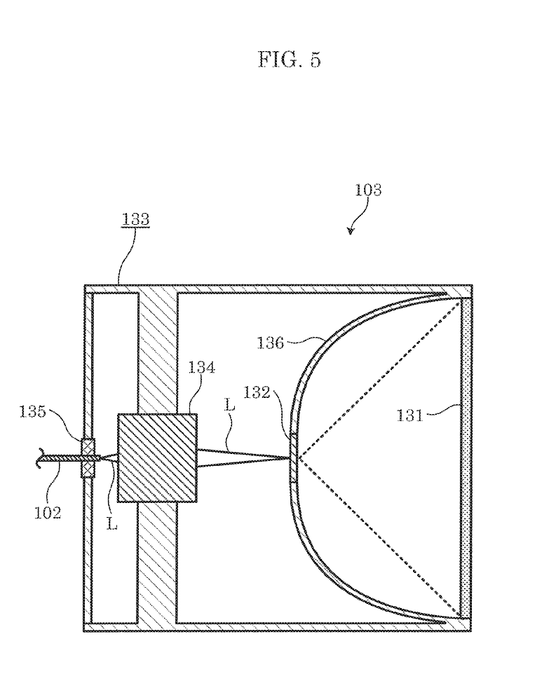

As illustrated in FIG. 1, light-emitting apparatus 100 further includes illuminating device 103 including second light-emitter 132 (see FIG. 5) which emits light based on laser light radiated from the end of light guide 123 which is opposite the end connected to laser light source 203.

FIG. 5 is a cross-sectional view of the illuminating device.

Illuminating device 103 does not make light-emitting apparatus 100 visible, but makes structures, etc. which reflect radiated light visible, and is a device capable of emitting a strong light over a narrower range than first light-emitter 124. As illustrated in FIG. 1 and FIG. 5, illuminating device 103 is a device which radiates visible light, with laser light L guided by light guide 123 as a light source, and includes second light-emitter 132, cover 131, case 133, optical system 134, fiber attachment portion 135, and reflector 136.

As illustrated in FIG. 5, when second light-emitter 132 is irradiated with laser light L, second light-emitter 132 emits light of a different wavelength from laser light L. Second light-emitter 132, for example, includes, in a dispersed state, phosphor particles which generate fluorescence when excited by laser light L, and irradiation with laser light L causes the phosphor to generate fluorescence that is of a different wavelength from laser light L. Specifically, second light-emitter 132 can be exemplified as a component in which phosphor particles are dispersed inside a transparent resin or glass base material as in first light-emitter 124, or a component in which phosphor particles are packed tightly together.

It should be noted that second light-emitter 132 does not follow the changes in the form of base body 101, and thus does not need to be flexible. Furthermore, the types and ratio of the phosphors included in second light-emitter 132 may be the same or different from the types and ratio of the phosphors included in first tight-emitter 124.

Furthermore, although in this embodiment second light-emitter 132 is of the transmission type including an irradiation face which is irradiated with laser light L and a face on the opposite side from which visible light is radiated, an arbitrary type, such as the reflection type, can be adopted for illuminating device 103.

Cover 131 is a component which covers the radiating side of second light-emitter 132, and has transparency that allows transmission of the visible light radiated from second light-emitter 132. In this embodiment, cover 131 has rigidity capable of withstanding water pressure, and has a light-distribution control structure which controls the distribution of light under water.

Case 133 is a component which protects second light-emitter 132, optical system 134, etc., and covers the path of laser light L. In this embodiment, a component or structure which absorbs laser light L is provided on the inner circumferential surface of case 133. In this embodiment, case 133 forms, together with cover 131, a sealed structure, and has rigidity capable of withstanding water pressure.

Optical system 134 is a set of lenses which are set to focus incident laser light L onto second light-emitter 132.

Fiber attachment portion 135 is a component for attaching the end of the endmost light-emitting component 102 on case 133 side to case 133. In this embodiment, fiber attachment portion 135 ensures the sealing between the attached light-emitting component 102 and case 133 such that water does not enter case 133.

Reflector 136 is a component that reflects, toward cover 131, light that does not directly reach cover 131 out of the light radiated from second light-emitter 132. In this embodiment, second light-emitter 132 is held by reflector 136.

(Reflecting Component)

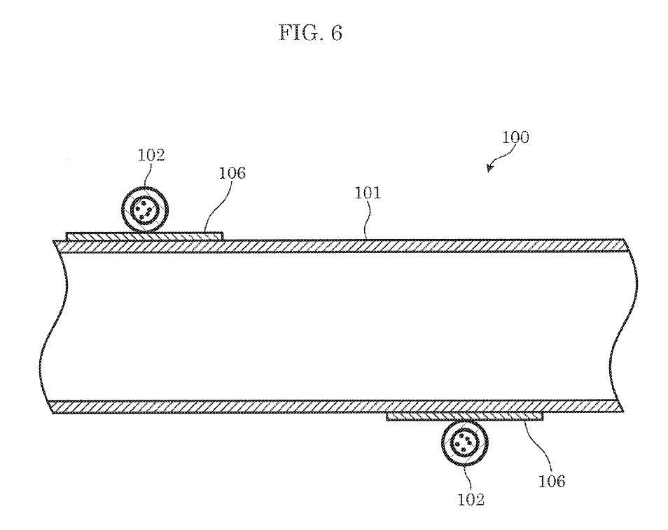

Furthermore, in this embodiment, light-emitting apparatus 100 includes, as illustrated in FIG. 2 and FIG. 6, reflecting component 106 which is disposed between base body 101 and light-emitting component 102, and reflects the light radiated from light-emitting component 102.

In this embodiment, reflecting component 106 is a tape-like component having one face with a reflecting function and the other face provided with an adhesive, and is stuck to the surface of cylindrical base body 101 in a spiral state corresponding to light-emitting component 102.

With light-emitting component 102 radiating light radially about the light-guiding direction of the laser light, disposing reflecting component 106 on the surface of base body 101 in this manner enables the light radiated toward base body 101 to be reflected in a direction away from base body 101, and thus enables the visibility of base body 101 to be improved.

It should be noted that reflecting component 106 need not only cause spectral reflection of the light from light-emitting component 102, and may cause scatter reflection.

[A Plurality Arranged in Series]

In this embodiment, in light-emitting apparatus 100, a plurality of light-emitting components 102 are attached to base body 101 at predetermined intervals (equal intervals, in this embodiment), as illustrated in FIG. 1. Furthermore, two light-emitting components 102 which are disposed apart are linked by one of linking components 104 which are capable of guiding the laser light, and light-emitting components 102 and linking components 104 are connected by connecting means 141.

(Linking Component)

Each of linking components 104 is a component which guides the light laser light from one of separately disposed light-emitting components 102 to another, and is what is called an optical fiber which has a core and cladding which extend along the same axis. Although there is no particular limitation on the material of linking component 104, since linking component 104 is attached to base body 101 in the same manner as light-emitting component 102, for example, a material that changes form flexibly following a change in the form of base body 101 is used.

In this embodiment, linking component 104 is attached spirally to the outer circumferential surface of base body 101, in the same manner as light-emitting component 102.

(Connecting Means)

Connecting means 141 are fittings that connect light-emitting components 102 and linking components 104 to enable the laser light to pass from light-emitting component 102 to linking component 104 and vice versa. Specifically, each of connecting means 141 is a connector which is disposed at an end of light guide 123 of light-emitting component 102 and an end of linking component 104 which are matched against each other, arid is capable of maintaining such matched state.

In this embodiment, connecting means 141 is placed under water, and is thus sealed to prevent water from entering the matched portions of light guide 123 of light-emitting component 102 and linking component 104.

As described above, disposing light-emitting components 102 at equal intervals makes it possible to visually recognize the depth of diver 202.

In addition, in this embodiment, the endmost light-emitting component 102 on laser light source 203 side is connected to laser light source 203 via a relatively long linking component 104.

Accordingly, the laser light can be guided efficiently up to the vicinity of diver 202, and thus it is possible to cause light-emitting component 102 disposed in the vicinity of diver 202 to emit light relatively strongly.

(Color Pattern)

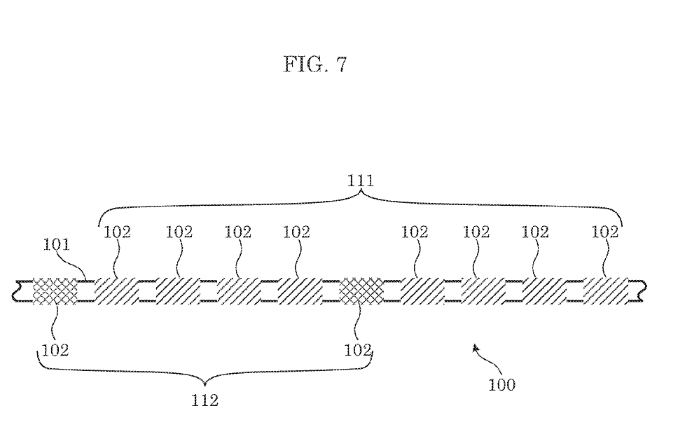

As previously described, in this embodiment, first light-emitter 124 radiates white light by including three types of phosphors. However, it is possible to cause first light-emitters 124 to radiate light of different colors to create a color pattern. For example, as illustrated in FIG. 7, among the plurality of light-emitting components 102 arranged on base body 101 at predetermined intervals, first light-emitting component group 111 emits a first light and second light-emitting component group 112 emits a second light different from the first light. Specifically, emission, of light of different colors from the same laser light is realized by differentiating the type, combination, or ratio of phosphors included in first light-emitters 124 of light-emitting components 102 belonging to first light-emitting component group 111 and the type, combination, or ratio of phosphors included in first light-emitters 124 of light-emitting components 102 belonging to second light-emitting component group 112.

Accordingly, since a pattern appears over the entirety of base body 101 due to the difference in color of light emitted by light-emitting components 102, the state of base body 101, for example, whether base body 101 is abnormally entangled, can be recognized at a glance. Furthermore, this is also useful when diver 202 wants to find out his/her position (depth).

[Advantageous Effects]

According to light-emitting apparatus 100 described above, the surroundings of base body 101 which is a hose for supplying breathing gas can be illuminated in a spiral pattern, and thus the presence of base body 101 can easily be recognized even in a deep sea where light does not reach.

Furthermore, since it is possible to cause light-emitting components 102 to emit light without using electricity (current), light-emission is not disrupted by short-circuiting, etc., even when used at sea, and thus high reliability can be ensured.

Furthermore, since light-emitting components 102 also bend following the bending of base body 101, that is, the portions emitting light in a line form follow a change in the form of base body 101, the state (form) of base body 101 can be easily recognized, and it is possible to determine whether there is excessive stress on base body 101.

Furthermore, since there is no need to worry about rust occurring at electrical contacts, etc., maintenance can be improved.

### Embodiment 2

Next, another embodiment of light-emitting apparatus 100 will be described using the drawings. It should be noted that the same reference sign is given to components (portions) having the same operation, function, shape, mechanism, or structure as in Embodiment 1, and their description may be omitted. Furthermore, hereinafter, description shall center on the points of difference from Embodiment 1, and there are instances where description of identical matter is omitted.

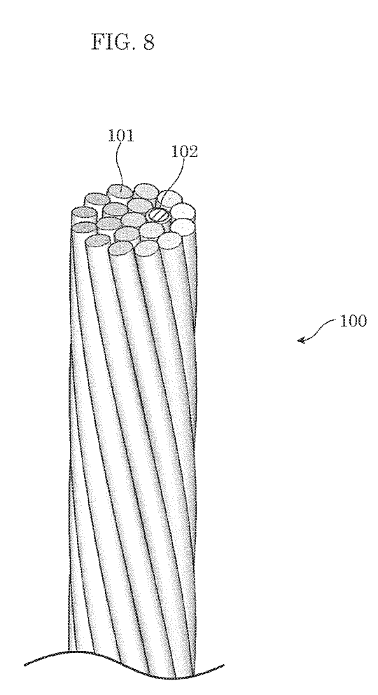

FIG. 8 is a cross-sectional perspective view of a portion of the light-emitting apparatus according to this embodiment.

As illustrated in the figure, light-emitting apparatus 100 is formed by twisting together light-emitting component 102 and a plurality of fibrous base bodies 101.

In this embodiment, base bodies 101 are disposed to cover the periphery of light-emitting component 102, and protect light-emitting component 102. Furthermore, base bodies 101 are fibers formed of a material, such as resin, which can transmit the light radiated by light-emitting component 102. Each of base bodies 101 forms a thread having the same diameter as light-emitting component 102 by twisting together fine fibers, and light-emitting component 102 is attached to base bodies 101 by twisting the threads and light-emitting component 102 together as illustrated in FIG. 8.

It should be noted that a rope-shaped light-emitting apparatus 100 may be formed by intertwining light-emitting component 102 and fibrous base bodies 101.

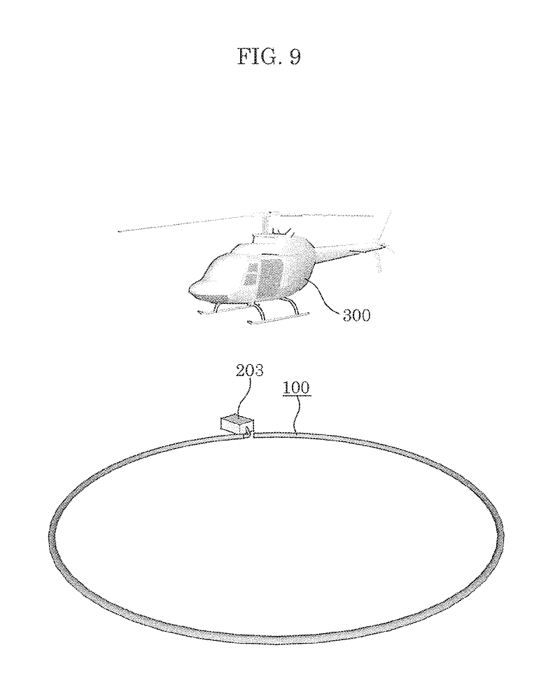

Accordingly, it is possible to cause the entirety of light-emitting apparatus 100 to emit light while protecting light-emitting component 102 by covering the periphery of light-emitting component 102 with fibrous base bodies 101, and thus light-emitting apparatus 100 can be stored in a compact state during normal times, and then deployed for use in situations such as during disasters. For example, as illustrated in FIG. 9, a landmark for indicating a temporary landing space of helicopter 300 at night can be formed using rope-shaped light-emitting apparatus 100.

It should be noted that the present disclosure is not limited to the foregoing embodiments. For example, another embodiment realized by arbitrarily combining structural components or excluding some structural elements described, in this written description may be included as an embodiment of the present disclosure. Furthermore, variations obtained by various modifications to the foregoing embodiments that can be conceived by a person having ordinary skill in the art, that are within the scope of the essence of the present disclosure, that is, the intended teachings of the recitations of the claims, are also included in the present disclosure.

For example, rope-shaped light-emitting apparatus 100 may be woven into a net. This makes it possible to provide a net, the entirety or a portion of which emits light.

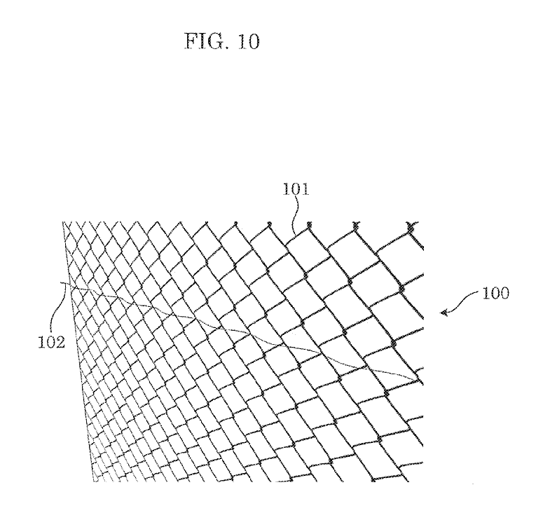

Furthermore, as illustrated in FIG. 10, light-emitting component 102 may be attached to by being sewn into base body 101 which is formed into a net.

In this manner, having a portion or the entirety of a net component emit light using light-emitting apparatus 100 can enhance a fish-gathering effect when used as a fishnet, and can enhance an effect of repelling certain animals when used as a fence, or the like.

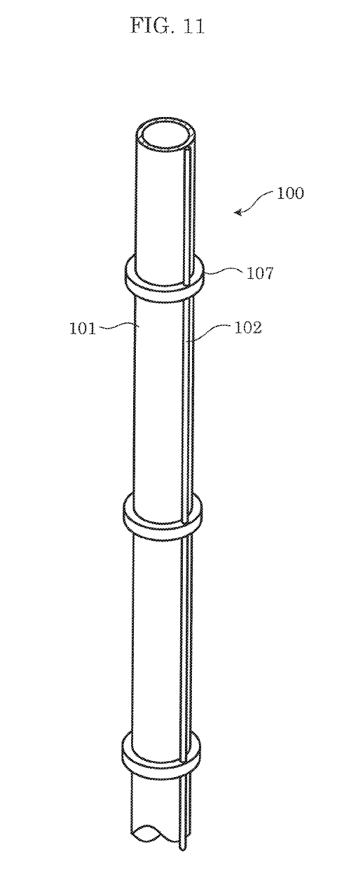

Furthermore, as illustrated in FIG. 11, light-emitting component 102 may be attached to base body 101 by using attachment fittings 107. In this case, even when the form of base body 101 changes, allowing sliding between attachment fittings 107 and light-emitting component 102 or between attachment fittings 107 and base body 101 enables light-emitting component 102 to flexibly follow the change in the form of base body 101 without warping. Furthermore, when attachment fittings 107 have a light-guiding ability to guide the light from light-emitting component 102, the light radiated from light-emitting component 102 causes light to be radiated from the entirety of attachment fittings 107. Therefore, even from a position at which light-emitting component 102 is hidden from view by base body 101, base body 101 can still be recognized by the light from attachment fittings 107.

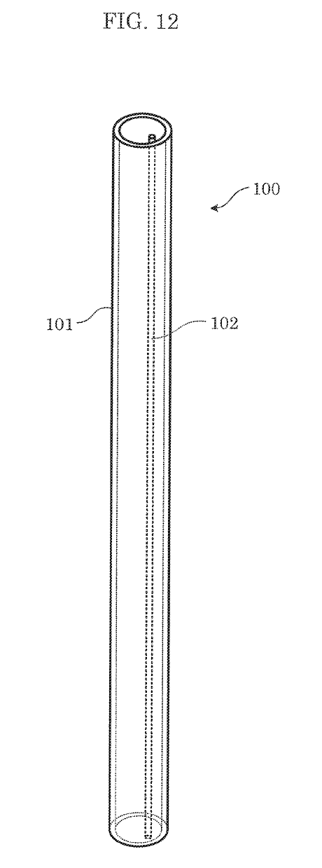

Furthermore, as illustrated in FIG. 12, base body 101 may be completely transparent or include a transparent portion, and light-emitting component 102 may be attached to base body 101 by being passed inside base body 101. Here, transparent means being highly transmissive of light radiated by light-emitting component 102.

Accordingly, the light from light-emitting component 102 enables base body 101 to be visible from any direction.

Furthermore, there is no particular limitation on the color of light radiated from light-emitting apparatus 100. For example, when light-emitting apparatus 100 is conceived for use in fog, light-emitting apparatus 100 may strongly emit yellow light.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light-emitting apparatus comprising:
a flexible base body; and
a light-emitting component attached to the flexible base body and having a form which changes flexibly following a change in a form of the flexible base body, the light-emitting component including:
a light guide which guides laser light that enters one end of the light guide;
a leaking means for causing part of the laser light guided by the light guide to leak out of the light guide in a direction which crosses a light-guiding direction; and
a first light-emitter which extends along the light-guiding direction and emits light based on the part of the laser light that is leaked out of the light guide by the leaking means.

2. The light-emitting apparatus according to claim 1, wherein the first light-emitter includes phosphor particles which generate fluorescence when excited by the laser light.

3. The light-emitting apparatus according to claim 1, wherein:
the light guide is an optical fiber having a core and a cladding, and
the leaking means includes optical light scatters dispersed inside the core.

4. The light emitting apparatus according claim 3, wherein the optical light scatters include beads.

5. The light-emitting apparatus according to claim 3, wherein the optical light scatters include cavities.

6. The light-emitting apparatus according to claim 1, wherein:
the light guide is an optical fiber having a core and a cladding, and
the leaking means includes portions of the cladding, which have a refractive index different from the cladding so as not to cause total internal reflection of the laser light passing inside the core.

7. The light-emitting apparatus according to claim 1, wherein:
the flexible base body has an elongated shape, and
the light-emitting component is attached spirally to an outer circumferential surface of the flexible base body.

8. The light-emitting apparatus according to claim 1, wherein the flexible base body is a hose for supplying a fluid.

9. The light-emitting apparatus according to claim 1, wherein:
a plurality of light-emitting components are attached to the flexible base body at predetermined intervals, each of the plurality of light-emitting components being the light-emitting component, and
the light-emitting apparatus further comprises a linking component which flexibly links the light guide of one of the plurality of light-emitting components and the light guide of an adjacent one of the plurality of light-emitting components.

10. The light-emitting apparatus according to claim 9,
wherein the plurality of light-emitting components includes a first light-emitting component group which emits first light and a second light-emitting component group which emits second light different in color from the first light.

11. The light-emitting apparatus according to claim 1, further comprising
an optical reflector which is disposed between the flexible base body and the light-emitting component, and reflects light emitted by the light-emitting component.

12. The light-emitting apparatus according to claim 1, further comprising
an attachment fitting which attaches the light-emitting component to the flexible base body, and has an ability to guide light emitted by the light-emitting component.

13. The light-emitting apparatus according to claim 1,
wherein the flexible base body includes a transparent portion, and
the light-emitting component is attached to the flexible base body by being passed inside the flexible base body.

14. The light-emitting apparatus according to claim 1,
wherein the flexible base body is one or more fibers, and
the light-emitting component is attached to the flexible base body by being twisted together or interwoven with the flexible base body.

15. The light-emitting apparatus according to claim 1,
wherein the flexible base body has a net shape.

16. The light-emitting apparatus according to claim 1, further comprising
an illuminating device including a second light-emitter which emits light based on the laser light emitted from another end of the light guide.

17. The light-emitting apparatus according to claim 16, wherein the second light-emitter includes phosphor particles which generate fluorescence when excited by the laser light.

18. A light-emitting apparatus comprising:
a flexible base body; and
a light-emitter attached to the flexible base body and having a form which changes flexibly following a change in a form of the flexible base body, the light-emitter including:
a light guide which guides laser light that enters one end of the light guide;
optical deflectors for causing part of the laser light guided by the light guide to leak out of the light guide in a direction which crosses a light-guiding direction; and
a fluorescence light-emitter which extends along the light-guiding direction and emits light based on the part of the laser light that is leaked out of the light guide by the optical deflectors.
